(19) United States
(12) Patent Application Publication
(10) Pub. No.: US 2004/0148187 A1
(43) Pub. Date: Jul. 29, 2004

(54) Method and device for generating an image of a network-like manufacturing process

(76) Inventors: Maren Boettcher, Stuttgart (DE); Monika Janocha, Stuttgart (DE); Sandra Kaiser, Plochingen (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/472,859

(22) PCT Filed: Feb. 9, 2002
(86) PCT No.: PCT/EP02/01369

(30) Foreign Application Priority Data
Mar. 27, 2001 (DE) 101 15 046.6

(51) Int. Cl. G06F 17/60

(52) U.S. Cl. 705/1

(57) ABSTRACT

The invention relates to a method that produce a map of a network of supply elements in a production process for a device for planning and/or for monitoring this production process. These supply elements supply a system provider or other supply elements with raw materials, semi-finished products, components and/or services. According to the inventive method, the system suppliers to the system provider first of all provide the required information, in particular obtaining the information for each system supplier about which previous suppliers supply that system supplier. The information which is required from these previous suppliers is then obtained, and after that the information from the suppliers previous to the previous suppliers. This information is used to compose the map of the network. One advantageous refinement defines how the network is traversed in order to set up the map in steps. The map that is generated at the network is stored in a process databank, to which the device for planning and/or monitoring has read access.

The invention relates to a method which produces a map of a network of supply elements for a production process, for a device which plans and/or monitors this production process for a system provider, and to a device which carries out this method.

The manufacture of a complex end product, for example of a motor vehicle, by a system provider is carried out using a hierarchical production process, in which a large number of different resources, in particular in the form of raw materials, semi-finished products, components and services are required in the successive production stages. The system provider obtains these resources from supply elements, in which case these supply elements may on the one hand be company-internal suppliers, or else on the other hand external suppliers. The expression “resources” in this case denotes a raw material, an initial product, a component or a service which a supply element in the network supplies to subsequent supply elements or to the system provider. In order to avoid supply and/or capacity bottlenecks in the supply to the system provider, the resources in the form of stocks and reserves are kept available in the supply elements, and tie up a considerable proportion of the capital. If these stored stocks are too great, then the capital tied up with them results in unnecessary costs; if the stored stocks are, on the other hand, too small, it is possible, particularly in the event of fluctuations in demand, for supply deadlines not to be complied with, and this likewise results in increased costs. There is thus a major requirement to plan and to optimize the available resources in the production process so as to minimize the costs involved with it. A further requirement is to monitor and to control the production process all the time. In particular, threats of supply bottlenecks can be identified at an early stage and short-term measures can be planned, when one supply element cannot provide a resource as required.

A realistic map of the entire production process and of its response when demand fluctuations occur is required for these activities. In order to obtain this map, the individual steps must be treated as parts of an integrated system which covers the entire production process. A planning and diagnosis system such as this, which is used to plan a complex production process for applications within a single company and can be kept up to date all the time is known, by way of example, from WO 98/08177.

However, if the production process also includes absolutely independent suppliers, who act freely on the market, then data that can be called up continuously about utilization levels, production and logistic processes, etc. at the supplier is generally not available for viewing by third parties, in particular by other suppliers and competitors, since it is part of the core know-how of that supplier. With regard to the description and planning of the production process, existing overall systems can therefore be used sensibly only for planning within a single company. The individual suppliers' planning instruments cannot interchange data with one another or with the planning instrument of the system provider. Existing overall systems can thus be used sensibly for planning only within a single company and do not work when they are distributed between different partners in different companies, and are linked to external suppliers.

DE 199 30 446 discloses a method and a device for monitoring the available resources in a production process continuously. The entire network of supply elements involved with the production process is mapped in a diagnosis system. This diagnosis system is used to monitor the production process continuously.

It should be remembered that the network is generally not a linear supply chain. One supply element may be supplied from two or more other supply elements. Conversely, one supply element may supply to two or more other supply elements. For example, a transporter can act as a supply element to convey products from a large number of other supply elements to a common recipient.

Formally, a network such as this is a directional graph with the system provider as the only root. One edge runs from a node for a first supply element to a node for a second supply element, while the first supply element produces an item or service for the second supply element. In addition, an edge runs from one supply element to the system provider when the supply element provides a product or a service directly to the system provider.

The object of DE 199 30 446 is to provide a diagnosis method and a diagnosis system which allow continuous monitoring of the available resources in a production process which include external supply elements. The object is achieved, inter alia, by using a map of the network and characteristic figures for the supply elements. DE 199 30 446 does not disclose how the map of this network is produced. The production of the map is not part of the object. The disclosure covers only the procedure for manually mapping the network in a planning and monitoring system, and of keeping it up to date manually. The required information is gathered by employees of the system provider making contact with the responsible employees of the supply elements, and asking for the required information. This procedure is time-consuming and susceptible to errors.

The invention is thus based on the object of providing a method which automatically produces a map of a network of supply elements in a production process of a system provider. The invention is also based on the object of providing a device for carrying out this method.

The object is achieved by a method as claimed in claim 1, and by a device as claimed in claim 41.

The method according to the invention (claim 1) produces a map of the network of supply elements for the production process. Three steps are carried out using a data processing system:

i) Information about the system provider is determined automatically, in particular the information about which supply elements supply directly to the system provider.

ii) Information about each supply element in the network is determined automatically, in particular the information about which other supply elements supply this supply element directly.

iii) The map of the network is formed automatically from the information about the service provider and about the supply elements.

One advantage of this method is that the only information which is required from each supply element is that which is available to the supply element, namely about the supply element itself and its previous suppliers. The map of the entire network is formed from local information such as this.

The resources which supply elements in the network supply to subsequent supply elements or to the system provider are, in particular, raw materials, semi-finished products, components and subsystems of the end product and/or services (claim 2).

One advantageous refinement of the method (claim 3) carries out the three steps by means of the following step elements:

The step i) comprises three step elements a), b) and c):

a) A data record for the system provider is created in a first data memory.

b) In addition, a data record is created for each system supplier in the first data memory. The system suppliers are those supply elements which supply the system provider directly. The information that is entered in the first data memory is the fact that that system supplier supplies the system provider directly.

c) In addition, an entry is produced for each system supplier to the system provider. These entries are entered in a second data memory for those supply element entries which still need to be processed.

Steps ii) and iii) are carried out successively, and the second data memory is processed in these steps, thus filling the first data memory. The step ii) comprises the step elements d), e), f) and g). The step iii) comprises the two step elements h) and i). The step elements comprise the following procedures:

d) One supply element L is chosen automatically by choosing an entry in the second data memory for a supply element L.

e) The chosen entry is evaluated in order to produce a question to the chosen supply element L.

f) The question provides information about the chosen supply element L, in particular the information about which other supply elements are supplied directly by the chosen supply element L.

g) The entry for the chosen supply element L is removed from the second data memory.

h) A data record for the previous supplier V is created, and the information that the previous supplier V supplies that supply element L is entered in the first data memory for each previous supplier V of the chosen supply element L.

i) An entry for the previous supplier V is produced for each previous supplier V of the supply element L, and is entered in the second data memory.

The second step and thus the advantageous refinement of the method is carried out repeatedly, to be precise until the second data memory, which is the memory for entries that still need to be processed, no longer contain an entry for a supply element.

This advantageous refinement defines how the network is traversed step-by-step by supply elements in order to produce the map.

The device for planning and/or monitoring the production process has read access, at least at times, to the first data memory (claim 4). In this refinement, the first data memory is advantageously a databank for permanent storage of data, and the second data memory is a random access memory in a data processing system (claim 5). The second data memory is a random access memory in that data processing system which is used for producing the map of the network (claim 6). This data processing system advantageously comprises a web server (claim 7).

The information from at least one supply element is advantageously obtained using an e-mail to this supply element (claim 8). A further refinement provides for the information about at least one supply element to be obtained using the Internet (claim 9).

The information about which supply elements supply the system provider directly is advantageously obtained from an electronic parts list of the product manufactured by the system provider (claim 10).

If a concern supplies various resources to subsequent supply elements in the network or to the system provider, a number of supply elements belong to the network, namely one for each resource. During the production of the map, the information about which resource a supply element supplies to the subsequent supply elements or to the system provider in the network is used at least once as a feature to distinguish between supply elements (claim 11). The map that is produced in the network comprises, for at least one supply element, the information about which resource this supply element supplies to subsequent supply elements or to the system provider for the network (claim 12). The variants in which this supply element supplies the resource are also stored (claim 13).

In a refinement of the method as claimed in claim 3 (claim 14), each supply element records and evaluates the information about what resource this supply element is supplying. Individual step elements of the method are modified as follows:

In step (b), a data record for the resource which a supply element supplies to the system provider is additionally stored in a third data memory. In addition, a cross-reference is produced from the data record in the first data memory for the supply element to the data record in the third data memory for the resource.

In step (d), a determination is also made as to which resource the chosen supply element supplies.

The information obtained about the chosen supply element in step f) includes the information about which other supply elements supply the chosen supply element, in order that the chosen supply element can supply the resource to subsequent supply elements or to the system provider.

In step g), a data record for the resource which the supplying supply element supplies to the supply element chosen in step (d) is created in the third data memory for each supply element which supplies the chosen supply element directly. A cross-reference is also produced from the data record in the first data memory for the supplying supply element to the data record in the third data memory for the resource.

In the method as claimed in claim 14, it is possible for two or more data records to be created for one supply element or one resource. This duplication is overcome by a third, additional method step (claim 15). This is carried out once the second data memory has no more entries for supply elements. The third method step comprises the following step elements:

For at least one resource, at least two data records for this resource are replaced by a single new data record for this resource in the third data memory.

All the data records for a supply element which supplies this resource to subsequent supply elements and/or to the system provider are replaced by a new data record for this supply element in the first data memory.

A cross-reference is produced from the new data record for the resource to the new data record for the supply element.

In addition, the designations which the supply elements and/or the system provider use/uses for the resources are stored in the third data memory (claim 16). These designations are preferably part numbers and names (claim 17).

In the refinements of the method described so far, it is possible for the same information to be obtained more than once from one supply element—specifically when the supply element supplies a resource to two or more subsequent supply elements. In order to avoid this, the information about which other supply elements that supply element supplies a resource to is obtained from at least one supply element (claim 18). This information is preferably obtained from the chosen supply element in step (f) (claim 19).

The information relating to the time at which a question was sent to a supply element in step e) is preferably stored for at least that supply element (claim 20). This information is part of the entry in the second data memory, and can be used to determine the time period which has passed since a question was sent to the chosen supply element. If this time period has exceeded a defined limit without a response having been received, another question is sent to this supply element (claim 21).

A further refinement of the method as claimed in claim 3 provides that in contrast to step g), a data record is created for a supply element which supplies the chosen supply element directly only if it is found automatically that the supplying supply element satisfies a specific criterion. Furthermore, in contrast to step h), an entry is created for a supply element which supplies the chosen supply element directly only when it is automatically found that the supplying supply element satisfies this criterion (claim 23). This avoids the map of the network being too large and unclear, and containing irrelevant information. The criterion preferably comprises a supply element being considered when it supplies a resource which was constructed for use in the end product which the system provider is manufacturing (claim 23). The supply element is ignored if it supplies a standard part or a part which is available throughout the world (claim 24).

A further refinement of the method as claimed in claim 3 (claim 25) is for at least one supply element to provide a complete map of the network element formed by previous supply elements. The chosen supply element is located at the end of this network element. The map of this network is stored in the first data memory. No entries for the previous suppliers of the chosen supply element are entered in the second data memory.

The network often has at least one supply element with a process stage in which the supply element produces a resource for subsequent supply elements or for the system provider. The map that is produced of the network preferably comprises the information about the processing time for this process stage (claim 26). Each supply element in the network has limited capacities for supplying resources to subsequent supply elements or to the system provider. These capacities may, for example, be manufacturing capacities or transport capacities. The map that is produced of the network preferably comprises, for at least one supply element, the information about the percentage utilization of the capacities of that supply element by supplying resources to subsequent supply elements or to the system provider (claim 27).

The network often also comprises at least one supply element with an output buffer in which the supply element temporarily stores resources which it produces for subsequent supply elements or for the system provider. The map that is produced of the network preferably comprises the information about the size of this output buffer (claim 28). In addition, the network often includes at least one supply element which uses an input buffer to temporarily store resources which are supplied to it from previous supply elements. The map that is produced of the network preferably comprises information about the size of this input buffer (claim 29).

For planning of the production process, it is advantageous for the lead time for at least one supply element to be determined (claim 30). The lead time describes the time interval between that time at which the supply element supplies a resource to subsequent supply elements or to the system provider for the network, and that time at which the system provider manufactures the end product using this resource or some other resource which is produced with the aid of this resource. The lead time of a supply element is preferably determined from the processing times of the subsequent supply elements (claim 31).

An overall parts list links at least one first resource, which a first supply element supplies to the system provider, with at least one second resource, which a second supply element in the network supplies directly or via a supply chain to the first supply element in order that it can manufacture the first resource. (claim 32). An overall parts list such as this is preferably produced using information which is stored in the third data memory, and using cross-references from data records in the first data memory to data records in the third data memory (claim 33).

It is likewise possible to automatically produce an interpreter list which, for at least one resource, links the designations which the supply elements which supply this resource use for this resource, to the designations which the supply elements which are supplied with these resources use for this resource, and the designation which the system provider uses for this resource (claim 34). An interpreter list such as this is preferably produced using information which is stored in the third data memory (claim 35).

The map which is produced of the network is preferably visualized using a directional graph (claim 36). One edge leads from a first supply element to a second supply element, when the first supply element supplies the second supply element. In order to emphasize specific supply elements in the directional graph, for example those which may become a bottleneck, one of a number of possible display forms is chosen automatically for each supply element in the network. This display form depends on at least one item of information about the supply element, determined automatically in step ii). Each node for a supply element in the network in the directional graph is visualized using the display form chosen for that supply element (claim 37). The information about the supply element is preferably the percentage utilization of the capacities of the supply element as a result of the supply of resources to subsequent supply elements or to the system provider. (claim 38).

The edges of the directional graph can also be displayed differently. One of a number of possible display forms is preferably chosen for each edge of the directional graph. The display form for an edge which connects a node for a first supply element to a node for a subsequent supply element or for the system provider depends on the resource which the first supply element supplies to the subsequent supply element or to the system provider (claim 39).

The methods which have been described so far produce a bottom-up map of the network, that is to say starting from the system provider in the opposite direction to the supply direction. The method as claimed in claim 40, in contrast, produces a top-down map of the network element, in this case starting from a specific supply element which is the source of this network element. The method comprises two steps.

The first step comprises two step elements a) and b):

a) A data record for the previously determined supply element and a data record for the system provider are produced in a first data memory.

b) An entry for the previously determined supply element is produced in a second data memory.

The next step comprises seven step elements c) to i):

c) A supply element is chosen by automatically choosing an entry for a supply element in the second data memory.

d) The chosen entry is evaluated in order to produce a question to the chosen supply element.

e) The question obtains information about the chosen supply element, comprising the information about which other supply elements the chosen supply element supplies directly, and whether the chosen supply element supplies the system provider directly.

f) A data record for the supplied supply element is created in the first data memory for each supply element which is supplied directly via the chosen supply element, and the information that the supplied supply element is supplied directly from the chosen supply element is entered in the first data memory.

g) If the chosen supply element supplies the system provider directly, the information that the system provider is supplied directly by the chosen supply element is entered in the first data memory.

h) An entry is produced in the second data memory for each supply element which is supplied directly from the chosen supply element.

i) The entry for the chosen supply element is removed from the second data memory.

The second step is repeated until the second data memory no longer contains any entry for a supply element.

The invention will be explained in the following text with reference to an exemplary embodiment which is illustrated in the drawings, in which:

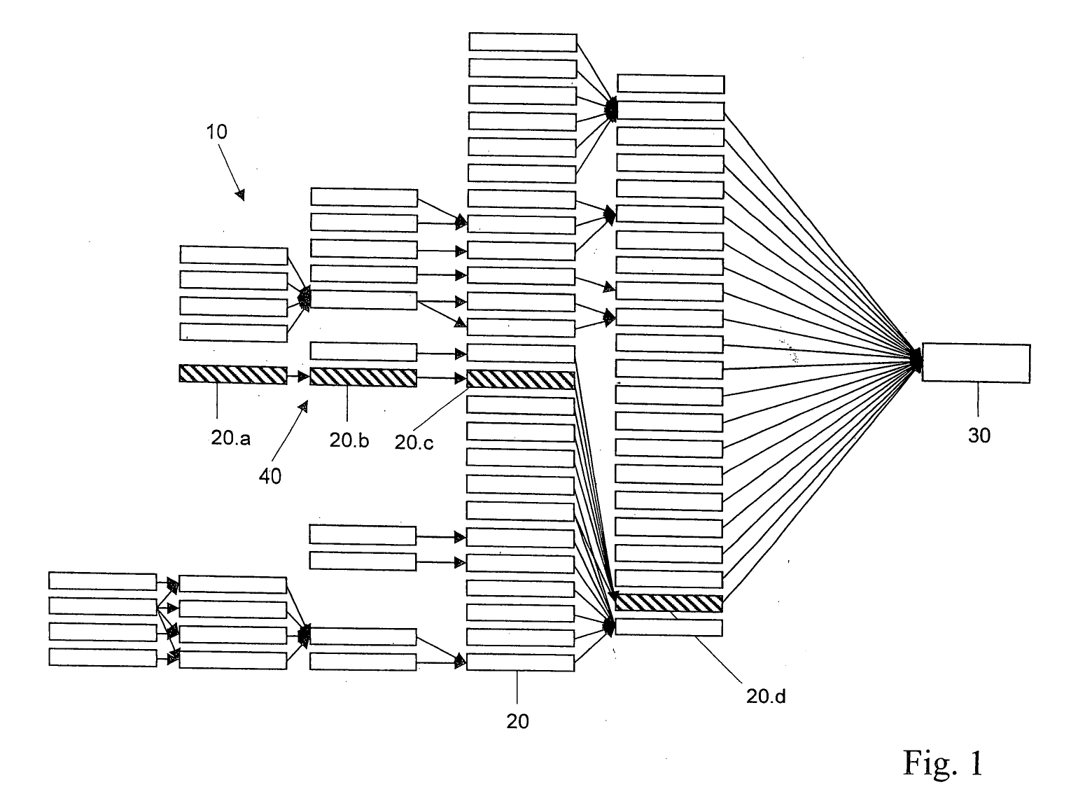

FIG. 1 shows a schematic illustration of a network of supply elements involved in a production process,

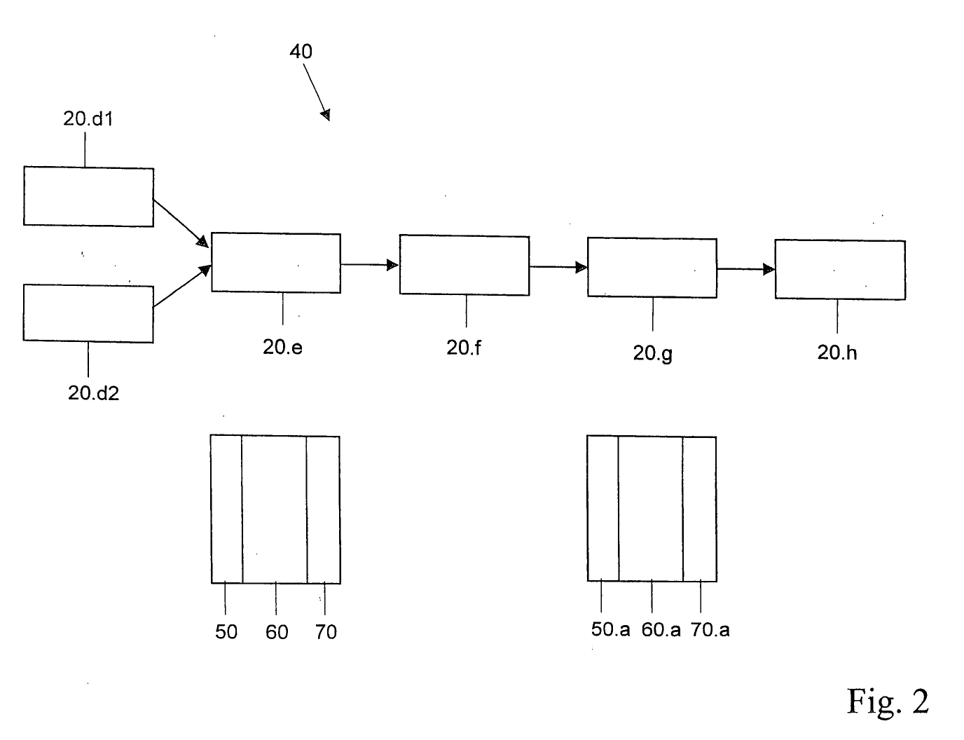

FIG. 2 shows a chosen supply chain in the network of the supply elements,

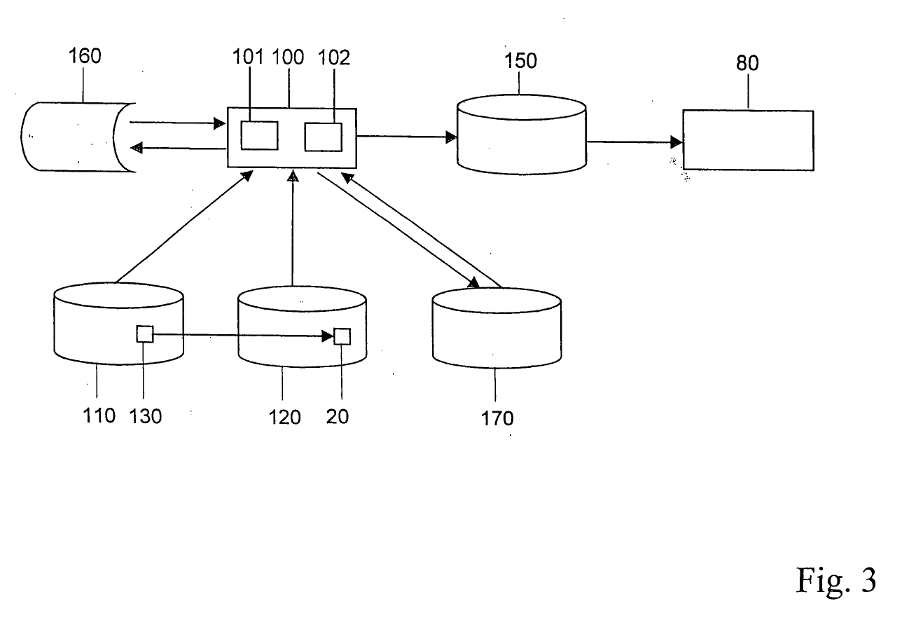

FIG. 3 shows a system architecture for a device which generates a map of the network,

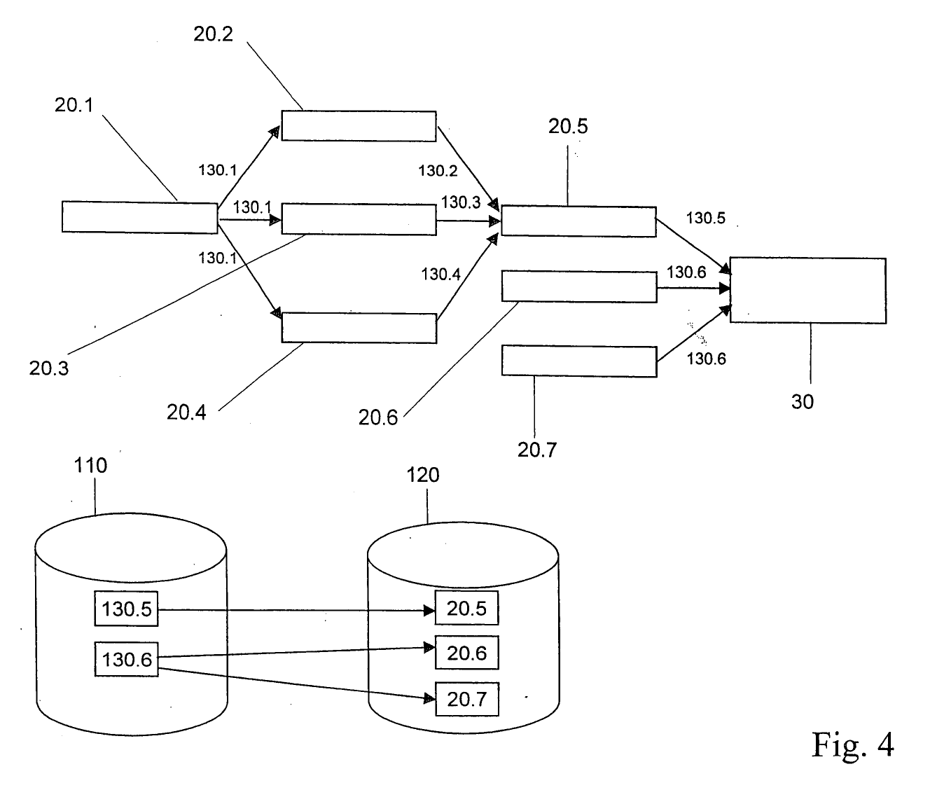

FIG. 4 shows an example of a network of supply elements,

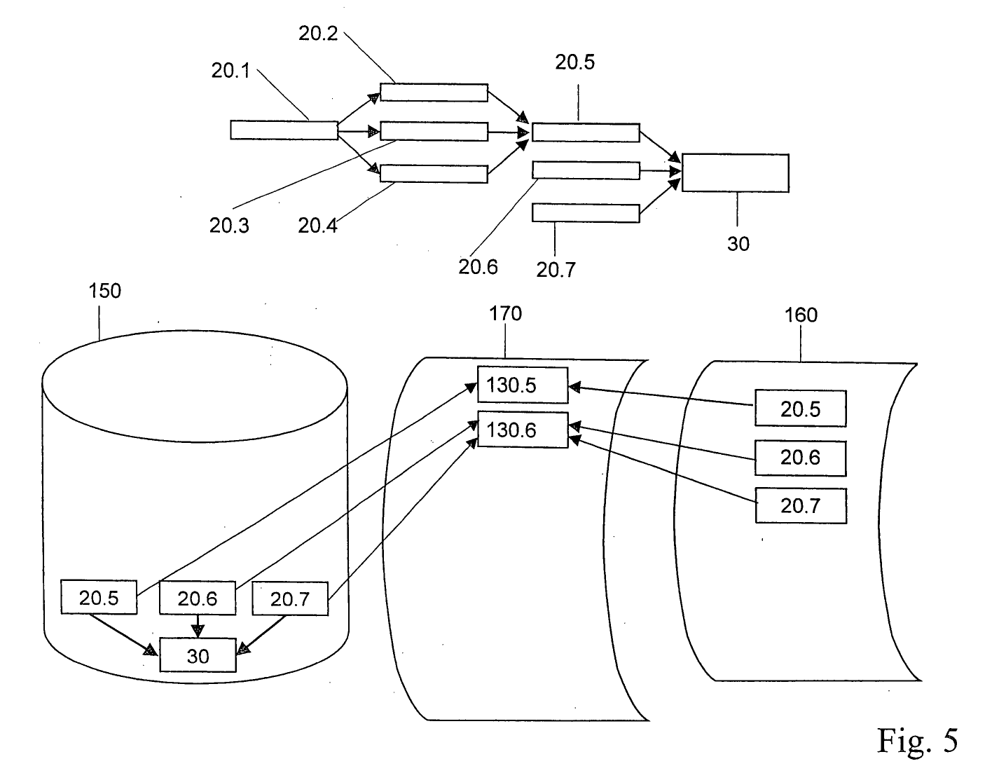

FIGS. 5 to 9 show the contents of data memories in the course of the generation process using the example shown in FIG. 4, and

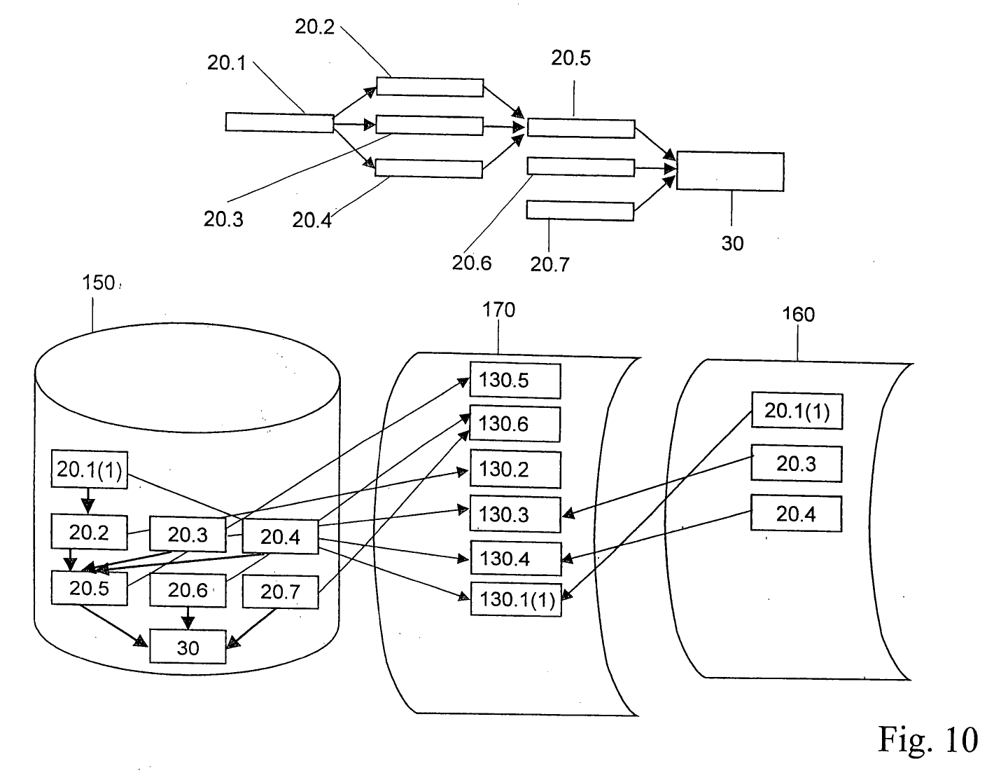

FIG. 10 illustrates a further refinement of the method.

FIG. 1 shows a map of a production process in which resources are provided by a network 10 of supply elements 20, using a system provider 30 in order to manufacture an end product. Resources are in this case in particular raw materials, semi-finished products, components and subsystems of the end product, but also include services. The expression “supply element” does not refer just to manufacturing workshops for physical resources, but also to those providing services. Each supply element 20 in this network 10 is represented in FIG. 1 in the form of a small box, and the arrows between the boxes indicate the supply direction between the supply elements 20. The supply elements 20 jointly supply the system provider 30, which represents the final element in the network 10. The two or more supply elements 20 within the network 10 are networked in the form of supply chains 40 such that they are dependent on one another, with one supply element 20 in each case supplying an item or items to the next supply element 20 in the supply sequence. An example of supply elements 20 which jointly represent a supply chain 40 such as this is illustrated in FIG. 1 by shading the small boxes for the supply elements involved. The supply element 20.a in the example in FIG. 1 supplies the supply element 20.b, the supply element 20.b for its part supplies the supply element 20.c, the supply element 20.c for its part supplies the supply element 20.d, and the supply element 20.d supplies the system provider 30. The supply elements 20.a to 20.d together form the supply chain illustrated in shaded form in FIG. 1.

If a concern is providing a single product or a single service for different recipients, it forms a single supply element with two or more subsequent supply elements. The supply chain thus branches at this point. If, in contrast, it supplies different products or services to different locations for the production process, then this concern is represented by two or more supply elements in the network. If, in particular, a transporter supplies different products to different recipients, then there are different supply elements for this transporter in the network.

FIG. 2 shows one specific example of a supply chain 40 which is formed from two or more supply elements 20; by way of example, this relates to the production process for leather components which are installed by the system provider 30 as part of the inner door lining for a passenger vehicle. The supply chain 40 comprises four manufacturing workshops 20.d1, 20.d2, 20.e, 20.g, three of which (the production workshops 20.d1 [cutting the leather for gray leather], 20.d2 [cutting the leather for non-gray leathers] and 20.e [sewing the leather]) are carried out in South Africa, and one (manufacturing workshop 20.g [partial assembly of door inner lining]) is carried out in Germany. The supply chain 40 also contains a transport concern 20.f, which transports the semi-finished leather products from South Africa to Germany, and the supply element 20.h [door inner lining final assembly]. As shown in FIG. 2, each supply element 20 has at least one process stage 60 which may comprise one or more production steps, transport steps, etc. and an output buffer 70.

If the supply element 20 is supplied by other supply elements, it has at least one input buffer 50. The buffers 50, 70 represent stored stocks and are used to at least partially decouple the material flow between different supply elements 20 located in the supply chain 40. For example, the input buffer 50.a in the manufacturing workshop 20.g ensures that the manufacturing workshop 20.g has sufficient semi-finished leather products for partial installation of the door inner lining until the next delivery. In order to allow the manufacturing workshops 20.d and 20.e or the transporter 20.f to continue to install door inner linings even in the event of delivery difficulties, it may be worthwhile for the delivery workshop 20.g to make its input buffer 50.a larger.

In the example shown in FIG. 2, the supply elements 20.f and 20.g have only one previous supplier, while 20.e has two previous suppliers. One supply element 20, which receives various raw materials or prefabricated items from a number of previous suppliers, may have different previous suppliers and thus different input buffers 50. In a corresponding manner, a supply element 20 which supplies two or more other supply elements may have two or more output buffers 70.

In order to plan and to optimize the available capacities in the production process and in order to identify threatened supply bottlenecks in good time and to plan measures at short notice, characteristic figures are required for the supply elements 20. These characteristic figures are obtained during the production of the map of the network, and are part of the map. The way in which these characteristic figures are obtained is described further below.

In one preferred refinement of the invention, the following characteristic figures are obtained for a supply element 20:

The processing time of the supply element 20. Particularly as a result of the process steps and the limited capacity, a supply element 20 requires a specific time to supply a resource to subsequent supply elements or to the system provider 30 once it has received the supply order and has received all the necessary resources from previous supply elements. For a transporter, the processing time is the time between receipt and delivery of the transported item or items. The time interval is referred to as the processing time.

The utilization level of the supply element 20. This utilization level indicates the percentage of the total capacity of the supply element 20 that is utilized in producing goods or services for subsequent supply elements in the network 10.

Note: It should be remembered that it is possible for the supply element 20 to also produce goods or services for concerns which are not included in the network 10.

The flexibility of the supply element, as known from DE 199 30 446, as a measure of the time period over which the supply element 20 is able to compensate for demand fluctuations from the system provider 30,

the time interval of the demand lead that the supply element receives from subsequent supply elements or from the system provider 30,

the size of the output buffer and the pipeline times through the output buffer of the supply element 20,

if the supply element 20 is supplied from other supply elements: the size of the input buffer and the pipeline times through the input buffer,

if the supply element 20 is supplied from other supply elements: the frequency with which the other supply elements supply the supply element 20, and the respective minimum order amount in each case, and

the variants in which the supply element 20 supplies a resource to subsequent supply elements or to the system provider 30.

The invention includes a method for producing a map of the network 10 of supply elements 20 in the production process for a specific product. A device 80 for planning and/or monitoring this production process as shown in FIG. 3 requires a map of this network. This map of the overall network is produced once by a generator 100 and is then evaluated by the device 80 whenever a planning or monitoring task has to be carried out. The generator 100 is a data processing system with a computer program for carrying out the method.

FIG. 3 shows the interaction of the generator 100 and of the device 80 with different data memories, which are described in the following text. An arrow from a data memory to a processing unit represents a read access, while an arrow to a data memory represents a write access.

At the start of the method, the generator 100 in FIG. 3 has read access at least at times to an electronic parts list 110 of the product, and in addition read access at least at times to an electronic supplier list 120 with information about those supply elements 20 which supply the system provider 30 with the parts mentioned in the parts list 110. These read accesses are represented by corresponding arrows in FIG. 3.

In the electronic parts list 110, each part is marked by the supply element that supplies this part to the system provider 30. This marking is preferably in the form of a cross-reference (link) from the data record which represents the part 130 in the parts list 110 to the data record which represents that supply element 20 in the supplier list 120 which supplies this part to the system provider 30. A unique name, an e-mail address and a postal address are stored for each supplier in the supplier list 120.

In addition, the generator 100 has write access to a process databank 150, which at the end of the method according to the invention contains the map of the network 10 of supply elements, including the characteristic values of all the supply elements 20 as required for planning or monitoring. During the course of the generation process for each supply element 20, the generator 100 creates a data record with a unique identifier for the supply element 20 in this process databank 150. At the start of the generation process, the process databank 150 contains only the data record for the system provider 30 creating the generator 100. At the end of the generation process, a data record is created in the process databank 150 for each supply element 20 in the network 10.

Furthermore, the generator 100 has read and write access to a resource data memory 170 with entries for resources. In addition, the resource data memory 170 is empty at the start of the generation process. A data record is created in the resource data memory 170 for each resource 130 at the end of the generation process.

It is possible for one concern to supply a resource to different recipients in the network 10. In this case, this concern has an associated supply element 20 with two or more subsequent supply elements in the network 10. However, it should also be remembered that one concern may supply n different resources to the system provider 30 and/or to other supply elements in the network 10. In this case, there are n different supply elements 20 associated with the network 10 of supply elements. These n supply elements 20 are distinguished on the one hand by an identifier for the concern and on the other hand by which n resources the n supply elements supply to the system provider 30 or to subsequent supply elements.

n different data records or entries for these n supply elements 20 are created in the process databank 150. These n data records or entries are distinguished by cross-references to the n different entries for resources in the resource data memory 170.

It should be remembered that the same resource is identified differently for different supply elements. A resource 130 is identified in the resource data memory 170 by the part numbers and the names which the supply elements which supply the resource 130 use for the resource 130, as well as by the part numbers and names which the supply elements 20 and/or the system provider 30 which are or is supplied with the resource 130 use or uses.

Furthermore, the generator 100 has read and write access to an electronic table 160, which is used only for the generation process. The table 160 lists the entries for those supply elements 20 from which information is still required in order to complete the production of the map of the network of supply elements 20. If a concern supplies n resources to subsequent supply elements, n entries for these n supply elements are created.

The table 160 is created at the start of the generation process, is initially empty and is no longer required after completion of the generation process. In the course of the generation process, the table 160 is filled with entries for specific supply elements 20, and this table has one line for each supply element. Each entry for a supply element 20 refers to the resource 130 which the supply element 20 supplies to subsequent supply elements or to the system provider 30. Each entry in the table 160 is provided with at least one timestamp, namely an identifier for the time at which a question was first sent to this supply element. If two or more messages are sent to the supply element in order to obtain information, the entry in the table 160 contains two or more timestamps. Furthermore, in the course of the generation process, entries for supply elements 20 are once again deleted from the table 160—specifically when all the information about that supply element 20 has been obtained. The entry for a supply element 20 comprises a unique identifier, which matches the identifier for the supply element 20 in the process databank 150, and an e-mail address for the supply element 20.

FIG. 4 shows, by way of example, a small network 10, a map of which is produced by the procedure according to the invention. The network 10 comprises the system provider 30 and the supply elements 20.1 to 20.7. The data records are each represented by rectangles, and the cross-references between data records are represented by arrows. There is a note on each arrow from a supply element 20.a to a subsequent supply element 20.b as to which resource that supply element 20.a supplies to the supply element 20.b. For example, the supply element 20.1 supplies the resource 130.1 to the supply elements 20.1, 20.3 and 20.4. The system provider 30 receives the resource 130.6 from the supply elements 20.6 and 20.7. The supply elements 20.5, 20.6 and 20.7 are the three system suppliers to the system provider 30, that is to say they supply the system provider 30 directly. The supply elements 20.2, 20.3 and 20.4 supply the supply element 20.5, and are thus previous suppliers to 20.5. The supply element 20.1 is a previous supplier to the three supply elements 20.2, 20.3 and 20.4.

FIG. 4 also shows the parts list 110 and the supplier list 120 for the system provider 30.

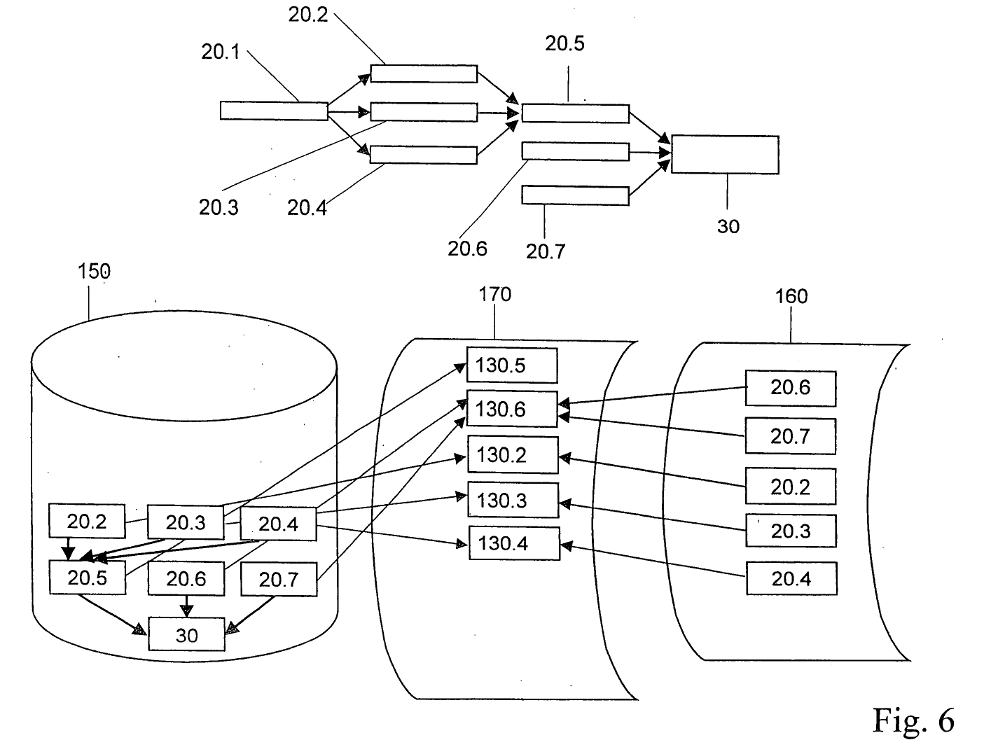

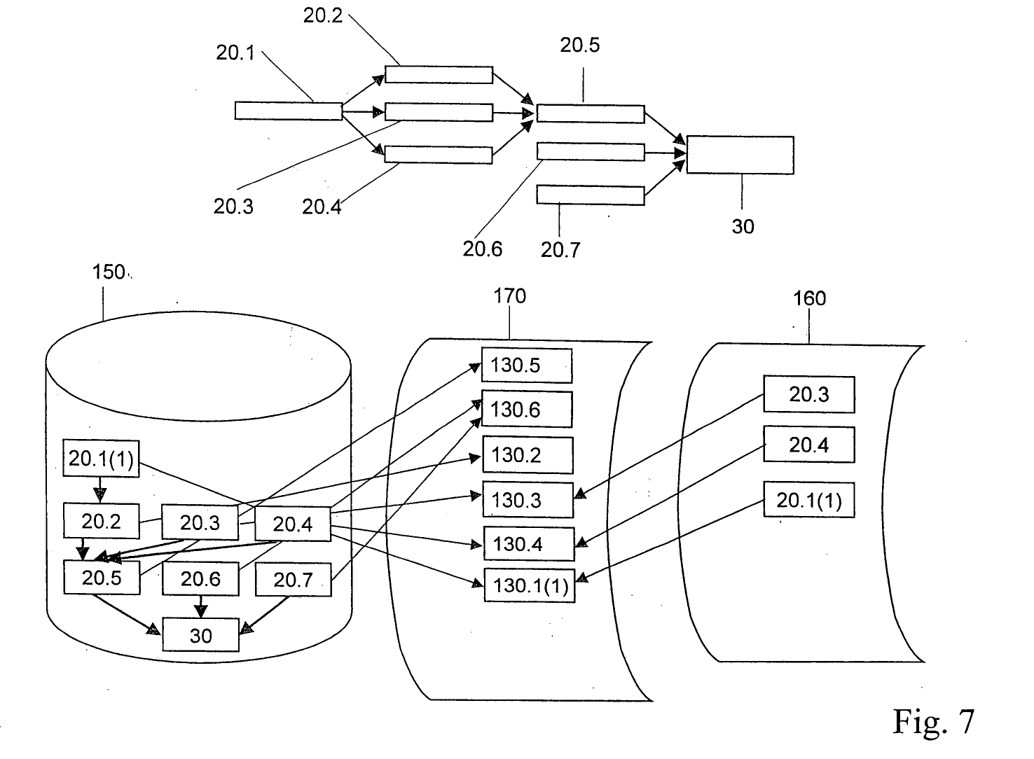

FIG. 5, FIG. 6 and FIG. 7 show the generation process on the basis of the detail from FIG. 4.

The generator 100 processes the electronic parts list 110 once, as described in the following text. For each part 130 for which a data record is created in the parts list 110, the generator 100 takes from the parts list 110 and from the supplier list 120 a unique name and the e-mail address of that supply element 20 which is supplying this part 130 to the system provider 30. The generator 100 creates a new data record for this supply element 20 in the process databank 150, in the form of a unique identifier for that supply element 20. The generator 100 produces a cross-reference from this data record for the supply element 20 to the data record for the system provider 30. In addition, the generator 100 creates a data record for the part 130 in the resource data memory 170, this being a part which is dealt with as a resource. The data record in the process databank 150 for the supply element 20 is provided with a cross-reference to this data record in the resource data memory 170. These cross-references jointly represent the information that the supply element 20 supplies the part 130 directly to the system provider 30. This information is shown in FIG. 5 by arrows from the supply elements to the system provider 30 and to the resources.

The data record for the resource 130 comprises the part numbers and identifies names which the system provider 130 and those supply elements which supply the resource 130 to the system provider 30 use for that resource 130. As a rule, the system provider 30 uses different part numbers and names for the same resource than a supply element which is supplying this resource.

Furthermore, the generator 100 creates an entry in the table 160 for the supply element 20, comprising the unique name of the supply element 20 as well as its e-mail address and postal address.

FIG. 5 shows the content of the process databank 150 and of the electronic table 160 after carrying out these method steps. The data records for the system provider 30 as well as the three system suppliers 20.5, 20.6 and 20.7 have been created in the process databank 150. Two data records for the resources 130.5 and 130.6 have been created in the resource data memory 170, and are identified by the part numbers and names that are used. ID_30, ID_20.6 and ID_20.7 are assumed to be the identifiers of the system provider 30 and of the supply elements 20.6 and 20.7, respectively, in the process databank 150. SN 30, SN_20.6 and SN_20.7 as well as Name_30, Name_20.6 and Name_20.7 are assumed to be the part numbers and designations, respectively, which the system provider 30 and the supply elements 20.6 and 20.7 use, respectively, for the resource 130.6.

The entry [(ID_30, SN_30, Name_30), (ID_20.6, SN_20.6, Name_20.6), (ID_20.7, SN_20.7, Name_20.7)] is associated with the data record for the resource 130.6 and is used to store the information about the part numbers and names.

The electronic table 160 contains entries for the three system suppliers 20.5, 20.6 and 20.7. These three entries are cross-referenced to the supplied resources 130.5 and 130.6.

The generator then processes the electronic table 160 repeatedly. An entry for a supply element 20.c is chosen in the table 160, and is evaluated. By evaluation of the corresponding entries and cross-references, the generator 100 determines the e-mail address of the supply element 20.c as well as the information about which resource 130.c the supply element 20.c supplies, and what part number and what name 20.c uses for the resource 130.c. A question in the form of an e-mail with this information is sent to the chosen supply element 20.c, in order to obtain the following data from the supply element 20.c: an electronic listing of all the previous suppliers of the supply element 20.c for the resource 130.c. This listing identifies that supply element 20.b which supplies a resource 130.b to the supply element 20.c in order that 20.c may itself supply the resource 130.c to subsequent supply elements 20 or to the system provider 30. In addition to the supply element 20.b, the listing names the resource 130.b, the part numbers and names which the supply elements 20.c and 20.b use for the resource 130.b, as well as an e-mail address and a postal address for the supply element 20.b.

characteristic figures for the supply element 20.c as required for planning and/or monitoring. The method works for any desired combination of characteristic figures for the supply elements, even when no characteristic figures whatsoever are required. The characteristic figures which are preferably obtained have been described above.

A timestamp for the time of the request to the supply element 20.c is stored in the electronic table 160.

Various methods and devices may be used in order to obtain this data. For example, the generator 100 submits an electronic form into the Internet using a website of the system provider 30, which downloads each supply element and sends it to the generator 100 with the required information. Alternatively, the generator 100 sends a file with a standardized structure, in which the supply element 20 enters the required data, as an e-mail attachment to the supply element. One such description format is the extended Markup Language (XML). Alternatively, the generator 100 analyzes a text file with the aid of a Perl script, using keywords for the data being searched for.

A monitoring unit 102 monitors the reception of messages from the supply elements 20.c and, for this purpose, evaluates the timestamps for the entries in the table 160. If no information or characteristic values have been received from a supply element 20 within a defined time period after the timestamp, a further question is automatically generated and sent to this supply element 20.c. The time at which the second message was sent is stored in the table 160. After a further defined time period, a question is once again generated and is sent to 20.c.

As soon as the information about previous suppliers and the characteristic values requested from a supply element 20.c have been transmitted to the generator 100, the generator 100 extracts from the data transmitted for the supply element 20.c the data for the supply element 20.c that is required for planning and/or monitoring, and adds this data to the data record for the supply element 20.c in the process databank 150. In addition, the generator 100 deletes the entry for the supply element 20.c from this table 160.

Furthermore, the generator 100 extracts the names and e-mail addresses of the previous suppliers of the supply element 20.c, that is to say those supply elements 20.b which supply a resource directly to the supply element 20.c, in order that the supply element 20.c can itself supply the resource 130.c. For each named previous supplier 20.b, the generator 100 extracts the part numbers and the names which the supply elements 20.c and 20.b use for the resource 130.b, as well as a name, an e-mail address and a postal address for 20.b.

It is, of course, possible for the supply element 20.c not to have any previous suppliers. Otherwise, for each supply element 20.b which names the supply element 20.c as a previous supplier, an operation unit 101 decides whether the supply element 20.b has or has not been considered by a data record in the process databank 150. In one preferred embodiment of the operation unit 101, a supply element 20.b is taken into account if it produces a resource 130.b specifically for the system provider 30, otherwise it is not. Information is in this case obtained from the supply element 20.c as to whether the resource 130.b supplied from the supply element 20.b to the supply element 20.c is a standard part or part available throughout the world, or whether the resource 130.b is specially manufactured. In another embodiment, the generator 100 has read access to a list with standardized parts and standardized designations. If the resource 130.b is contained in this list, the supply element 20.b is not taken into account in the process databank 150. In a third embodiment a maximum depth n is defined for the map of the network 10. The map includes only those supply elements 20 which are connected to the system provider 30 by a supply chain which has at most n elements, including the system provider 30.

The operation unit 101 also makes the decision as to whether a transporter is taken into account by a data record in the process databank 150. In one refinement of the decision rule, a transporter is taken into account if it is evident from the information obtained from that transporter that this transporter has a suitable store for the transport of resources which are used in the network 10.

If the operation unit 101 produces the result that the supply element 20.b is taken into account in the process databank 150, then a new data record is created for 20.b in the process databank 150, and a new data record is created for the resource 130.b in the resource databank 170. The data record for the resource 130.b contains the information about the part numbers and names which the supply elements 20.c and 20.b use for the resource 130.b.

One exception: If the supply element 20.c receives the same resource 130.b from two supply elements 20.b1 and 20.b2, then only one data record is created for the resource 130.b in 170. This data record contains the information about the part numbers and names which the supply elements 20.c, 20.b1 and 20.b2 use for the resource 130.b, preferably in the form of the entry:

[(ID_20.c, SN_20.c, Name_20.c),

(ID_20.b1, SN_20.b1, Name_20.b1),

(ID_20.b2, SN_20.b2, Name_20.b2)]

The new data record in the process databank 150 for the supply element 20.b is provided with a cross-reference to the data record for the supply element 20.c in the process databank 150. This results in storage of the information that the supply element 20.b supplies the supply element 20.c.

In addition, an entry is created in the table 160 for the supply element 20.b, comprising the unique identifier and the e-mail address of the supply element 20.b. This entry is provided with a cross-reference to the data record for the resource 130.b in the resource data memory 170.

FIG. 6 shows the content of the process databank 150, of the electronic table 160 and of the resource data memory 170 once the information from the supply element 20.5 has been evaluated. The operation unit 101 has produced the result that the three supply elements 20.2, 20.3 and 20.4 are taken into account. Data records for the previous suppliers 20.2, 20.3 and 20.4 have been generated in the process databank 150, and entries have been generated in the electronic table 160. Data records have been created in the resource data memory 170 for the resources which 20.5 receives from 20.2, 20.3 and 20.4.

FIG. 7 shows the content of the process databank 150, of the electronic table 160 and of the resource data memory 170 once the information from the supply element 20.2 has been evaluated.

The processing of the electronic table 160 as described above is carried out repeatedly, to be precise until the table 160 is empty, that is to say there are no more entries for supply elements 20 in it. As soon as the table 160 is empty, the map of the network 10 of supply elements 20 has been completed. There is at least one data record for each supply element in the process databank 160. Data records for supply elements which belong to the same concern can be distinguished by cross-references to different resources. The data records also include the data about the supply elements 20, as required for planning and/or monitoring.

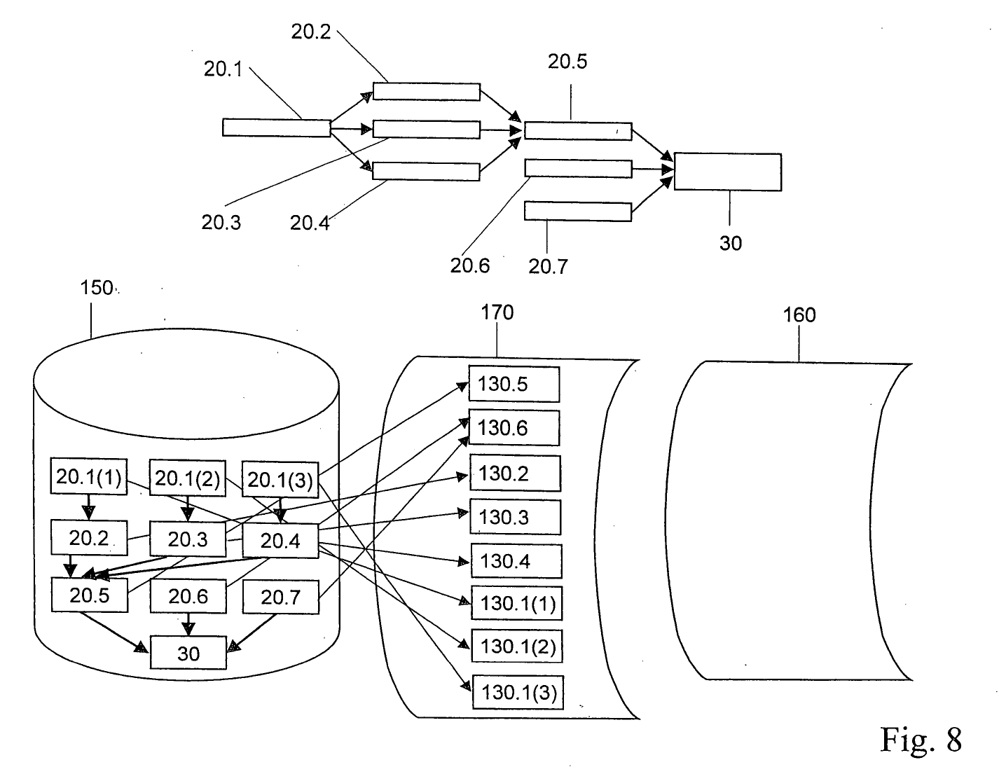

FIG. 8 shows the content of the process databank 150, of the electronic table 160 and of the resource databank 170 once the information from the supply elements 20.3 and 20.4 has been evaluated. The electronic table 160 is now empty. The supply element 20.1 supplies the resource 130.1 to the three supply elements 20.2, 20.3 and 20.4. The supply elements 20.2, 20.3 and 20.4 use different part numbers and names for this resource. Three requests have thus been generated to the supply element 20.1 on the basis of the resource 130.1. Three data records for the supply element 20.1 are created in the process databank 150, and are identified in FIG. 8 as 20.1(1), 20.1(2) and 20.1(3). Three data records for the resource 130.1 are created in the process databank 150, and are identified in FIG. 8 as 130.1(1), 130.1(2) and 130.1(3).

The duplications which are caused by one supplying element 20 supplying the same resource to two or more subsequent supply elements are now corrected in a subsequent method step. This subsequent method step will be described with reference to the example in FIG. 8. SN_130.1 is assumed to be the part number which the supply element 20.1 uses for the resource 130.1. The process automatically identifies that the data records 130.1(1), 130.1(2) and 130.1(3) represent the same resource 130.1. This is identified by the fact that all three data records contain the information that the supply element 20.1 uses the part number SN_130.1 for the resource 130.1.

The process determines which data records in the process databank 150 cross-refer to the three data records 130.1(1), 130.1(2) and 130.1(3). In the example in FIG. 8, these are the data records 20.1(1), 20.1(2) and 20.1(3). It is found that all three data records are associated with the same supply element. This is determined from the fact that it is found that:

20.1(1), 20.1(2) and 20.1(3) supply the resources 130.1(1), 130.1(2) and 130.1(3) which are the same resource 130.1, and

20.1(1), 20.1(2) and 20.1(3) have the same identifier for a concern. Note: this second check is important in order to distinguish between the situation in which one supply element supplies a resource to two or more supply elements, and the situation illustrated in FIG. 4 and FIG. 5 in which two or more supply elements supply the same resource.

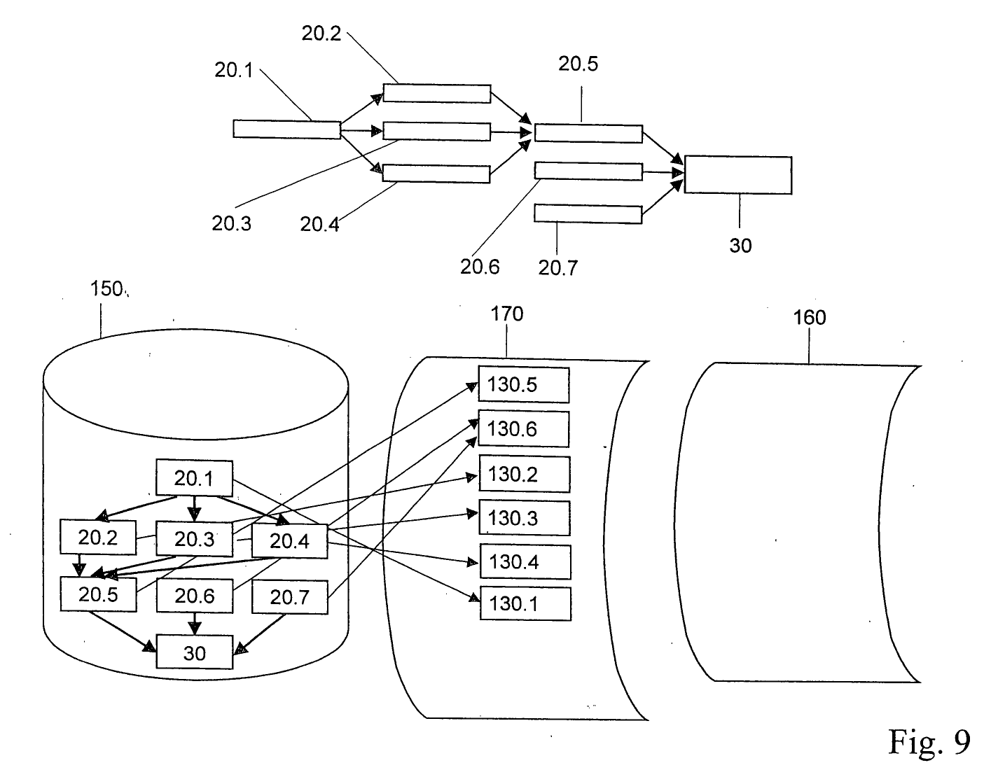

The three data records 130.1(1), 130.1(2) and 130.1(3) in the resource data memory 170 are replaced by a single data record for the resource 130. The three data records 20.1(1), 20.1(2) and 20.1(3) in the process databank 150 are replaced by a single data record for 20.1. FIG. 9 shows the content of the process databank 150, of the electronic table 160 and of the resource data memory 170 as well as the cross-references between data records after this method step has been carried out. The map of the network is complete once the following method step has been completed.

The refinement of the method just described has the disadvantage that the same resource 130 results in a message being sent two or more times to one supply element in order to determine the previous suppliers for this resource. In the example shown in FIG. 8, a message is sent to the supply element 20.1 three times on the basis of the resource 130.1. A different refinement avoids this disadvantage. The first e-mail to the chosen supply element 20.c provides additional data, namely a listing of all the customers of the supply element 20.c in the network 10, that is to say all the subsequent supply elements of the network 10 and/or the system provider 30, to which the supply element 20.c supplies the resource 130.c. Customers of the supply element 20.c outside the network 10 are ignored. An alternative refinement proposes that the map of the network as produced so far be transmitted to the chosen supply element 20.c. All the customers of the supply element 20.c that are still missing from the map are obtained by the first e-mail to the supply element 20.c, that is to say all the supply elements of the network 10 and/or the system provider 30 to which the supply element 20.c supplies the resource 130.c and which have not yet been taken into account in the map of the network which was transmitted prior to this to the supply element 20.c.

This refinement requires that the most recently produced entry in the table 160 for a supply element be processed first. Once the information from the supply element 20.2 has been evaluated, the process databank 150, the electronic table 160 and the resource data memory 170 will, according to this refinement, have the content shown in FIG. 10 rather than that shown in FIG. 7. The supply element 20.1 is the next to be chosen. The information about which other supply elements, that is to say which customers, are supplied by the supply element 20.1 with the resource 130.1, and what part numbers and names these customers use for the resource 130.1, is obtained from this supply element 20.1. This information is evaluated in order to identify the fact that the supply element 20.1 supplies the resource 130.1 to the three supply elements 20.2, 20.3 and 20.4.

The idea on which this refinement is based can be expanded in order to produce a map of a network element 10, namely of the network element whose root is a specific, previously chosen supply element 20. Furthermore, a resource 130 is chosen. The information about which customers, that is to say which supply elements 20.b in the network 10, are supplied by the supply element 20 with the resource 130, is obtained from this supply element. Information about the customers of the supply element 20 is once again obtained from these customers. The method ends when the system provider 30 or a concern outside the network 10 is named in this information. The refinements described above can be used in an analogous manner.

A further modification of this refinement provides for the map of the network to be composed of network elements. At least one chosen supply element 20.c is provided with a copy of the generator 100. The supply element 20.c uses the copy in order to automatically generate a map of that network element at whose end the supply element 20.c is located. This map thus describes the production process for the resource supplied by the supply element 20.c.

The map of the overall network at whose end the system provider 30 is located is produced using the method described above and as claimed in claim 2. As soon as the entry for this supply element 20.c is chosen in the table 160 and a question is sent to the supply element 20.c, not only is the data (required for planning and/or for monitoring) about the supply element 20.c and its direct previous suppliers obtained, but the complete map of the network element for the chosen supplier element 20.c is also obtained. There is no need to obtain any more data from the previous suppliers to the supply element 20.c in this method step, and in consequence no more entries are produced for them in the table 160.

The map of the network is, in a further refinement, used to determine characteristic figures of the overall network, required for planning and/or for monitoring. One characteristic figure is the lead time 6. The lead time 6 for the supply element 20 corresponds to the average time interval between an item or items leaving the supply element 20 and the item or items being received at the system provider 30. The lead time for those supply elements which supply the system provider 30 directly is 0; this is because the transporters who supply the system provider 30 are also treated as supply elements. The lead time 6 for the other supply elements is determined as the sum of the processing times of all those supply elements which follow the supply element 20 in a supply chain 40. If a supply element 20 is a component of two or more supply chains 40, then the largest sum of the processing times of the supply elements in these supply chains is used as the total lead time δ.

A further characteristic figure is the number of variants. Many resources are supplied to a supply element 20 in different variants. The variant which the supply element 20 itself supplies is thus subject to variants. 130.1, . . . , 130.n are assumed to be the n resources which a supply element 20 receives from previous supply elements. N_1, . . . , N_n are assumed to be the number of variants of these resources. If these variants can be combined independently of one another, the resource which the supply element 20 supplies in theory has N_1* . . . * N_n variants. The number of variants in which a resource is supplied to subsequent supply elements or to the system provider is taken from the information which is obtained from a supply element 20. Different variants of one resource have different names and part numbers. The data record for the resource comprises the information about the various variants and their names and part numbers.

It is often expedient for the device 80 to have read access to an overall parts list. This overall parts list contains all the information about the configuration of the end product of the system provider 30, from the raw materials, semi-finished products and intermediate products provided by the supply elements 20. This also shows the relationship between the names and part numbers of the supply elements 20, and those of the system provider 30.

Thus, for example, a large leather blank and three identical small leather blanks are required as supplied parts to produce the inner lining for a door, which has the part number “13687.99” with the system provider 30.

These leather blanks are identified by the supply element 20 by the part numbers “LZ 3458-7” and “LZ 3469-2”. The comprehensive parts list thus contains the information that a part with the number “LZ 3458-7” and three parts with the number “LZ 3469-2” are required from the supply element 20 in order to produce each door inner lining, and are jointly associated with the part with the number “13687.99” in the terminology of the system provider 30.

One refinement of the method according to the invention results in the overall parts list being produced automatically. The resource databank 170 contains, for each resource 130, the names and part numbers used for this resource 130 by those supply elements 20 which supply this resource 130 or which are supplied with this resource. At least when the resource 130 is supplied to the system provider 30, the names and part numbers used by the system provider 30 for the resource are also stored in the resource databank 170.

The generator 100 produces this overall parts list by making one run through the electronic parts list 110. A data record is created in the resource databank for each part 130. The generator uses this data record to find the names and part numbers which the system provider 30 and the supply element which supplies the part 130 to the system provider 30 use for this part 130. The generator 100 makes use of this read access to the process databank 150 and thus to the map of the network 10 produced according to the invention to determine which supply element 20 supplies the part 130, and which other supply elements supply what resources to the supply element 20 for this purpose. The generator once again takes the names and part numbers for these resources from the resource databank. Overall, this results in an overall parts list with all the names and part numbers.

An alternative refinement proposes that an interpreter list be produced instead of the overall parts list. The interpreter list does not link the resources, names and part numbers of the system provider 30 with those of the supply elements 20, but carries out a comparison process for each resource 130 to determine the names and part numbers used by the supply elements which supply this resource, and the names and part numbers used by the supply elements which are supplied with this resource. The names and part numbers of customers and suppliers in the network 10 are thus compared with one another. This is done by evaluating the data records in the resource databank 170. Each data record for one resource comprises the information as to which supply element uses what name and what part number for this resource.

The map of the network is visualized by suitable graphics displays. The information for visualization is obtained automatically from the process databank 150. These graphics displays are directional graphs with the system provider 30 as the root. Various graphics displays can be produced automatically:

a display in which each supply element is represented by its own node,

a display in which specific supply elements are identified by emphasis. A decision rule is used to determine which supply elements are identified by emphasis. The supply elements which are identified by emphasis are preferably those:

whose capacity is utilized to a high percentage rate by the supply of resources which are used in the network 10,

which have a long processing time

or which supply the resources with a large number of variants,

a display in which one of two or more possible display forms is chosen for each supply element, for example a traffic light function. For example, a supply element whose capacities are not more than 50% utilized by the supply of resources which are used in the network 10 is illustrated in green. A supply element which is more than 50% but less than 80% utilized is displayed in yellow, and one which is utilized to a level of 80% or more is displayed in red.

a display in which different supply elements which are associated with the same concern are displayed by a single node. An edge that is represented by an arrow from B to A is generated for each resource which this concern A receives from another concern B which is represented in the network. This display shows the significance of a concern in the network.

a display which shows which supply elements are supplied by a specific supply element 20. This display has the supply element 20 as its root, the supply elements supplied by the supply element 20 as subsequent supply elements, and the system provider 30 as a leaf. This display is used in particular to determine threats of supply difficulties or even failure of the supply element 20, and which other supply elements this event affects.

a display which shows which supply elements use a specific resource 130. The roots of this display are all the supply elements 20 which supply the resource 130 to subsequent supply elements, the supply elements supplied by the supply element 20 as subsequent supply elements, and the system provider 30 as a leaf.

The edges of the directional graph can also be displayed differently. The resources which are stored in the resource databank are preferably subdivided into categories, and the edge from a node for a first supply element 20.1 to a node for a subsequent supply element 20.2 or to the system provider 30 is displayed as a function of the category associated with that resource, which the first supply element 20.1 supplies to the subsequent supply element 20.2 or to the system provider 30.

1. A method for producing a map of a network (10) of supply elements (20) in a production process
in which the supply elements (20) comprise workshops and/or service providers,
in which resources are supplied from two or more supply elements (20) to a system provider (30) who uses these resources to manufacture an end product,
in which any desired number of supply elements (20) reside relative to one another in a networked supply chain (40) so that they are in turn supplied with resources from other supply elements (20),
with the method comprising the steps, which are carried out using at least one data processing system, that
i) information about the system provider (30) is determined automatically, including information as to which supply elements (20) supply the system provider (30) directly,
ii) information is determined automatically about each supply element (20), comprising information about which other supply elements supply this supply element (20) directly,
iii) the map of the network (10) is formed automatically from the determined information about the service provider (30) and about the supply elements (20).

2. The method as claimed in claim 1,
characterized in that
the resources comprise raw materials, semi-finished products, components and subsystems of the end product and/or of services.

3. The method as claimed in claim 1,
characterized in that
the step i) is carried out first of all and the step i) comprises three step elements (a), (b) and (c), with
(a) a data record for the service provider (30) being produced in a first data memory (150),
(b) a data record being produced, and the information that this supply element (20) supplies the service provider (30) directly being entered in the first data memory (150) for each supply element (20) which supplies the service provider (30) directly,
(c) an entry being produced in a second data memory (160) for each supply element (20) which supplies the system provider (30) directly,
in that steps ii) and iii) are carried out successively,
in that step ii) comprises three step elements (d), (e), (f) and (g),
and in that step iii) comprises three step elements (h) and (i),
with
(d) a supply element (20.c) being chosen by automatically choosing an entry for a supply element (20.c) in the second data memory (160),
(e) the chosen entry being evaluated in order to produce a question for the chosen supply element (20.c),
(f) the question creating information about the chosen supply element (20.c) comprising information about which other supply elements supply the chosen supply element (20.c),
(g) the entry for the chosen supply element (20.c) being removed from the second data memory (160),
(h) a data record for the supplying supply element (20.b) being created in the first data memory (150), and the information that the supplying supply element (20.b) supplies the selected supply element (20.c) directly being entered in the first data memory (150) for each supply element (20.b) which supplies the chosen supply element (20.c) directly,
(i) an entry being produced in the second data memory (160) for each supply element (20.b) which supplies the selected supply element (20.c) directly, and
and in that steps ii) and iii) are repeated until the second data memory (160) no longer contains any entry for a supply element (20).

4. The method as claimed in claim 3,
characterized in that
a device (80) is provided for planning and/or monitoring the production process
and has read access to the first data memory (150) at least at times.

5. The method as claimed in claim 3,
characterized in that
the first data memory (150) is a databank for permanent storage of data
and the second data memory (160) is a random access memory in a data processing system.

6. The method as claimed in claim 3,
characterized in that
the second data memory (160) is a random access memory in a data processing system (100) which is used for producing the map of the network (10).

7. The method as claimed in claim 1,
characterized in that
at least one data processing system which is used comprises a web server.

8. The method as claimed in claim 1,
characterized in that
information is created for at least one supply element (20) by using an e-mail to this supply element.

9. The method as claimed in claim 1,
characterized in that
information is created for at least one supply element (20) using the Internet.

10. The method as claimed in claim 1,
characterized in that
the information about which supply elements (20) supply the system provider (30) directly is produced using an electronically available parts list (110) for the end product that is manufactured by the system provider (30).

11. The method as claimed in claim 1,
characterized in that
the information about which resource a supply element (20) supplies to the subsequent supply elements or to the system provider (30) in the network (10),
is used at least once during the production of the map of the network (10),
as a feature for distinguishing between supply elements.

12. The method as claimed in claim 1,
characterized in that,
for at least one supply element (20) in the network (10), the map that is produced of the network (10) includes the information about which resource this supply element (20) supplies to subsequent supply elements or to the system provider (30) in the network (10).

13. The method as claimed in claim 12,
characterized in that,
for that supply element, the map that is produced of the network (10) includes the information about the variants in which the supply element supplies the resource.

14. The method as claimed in claim 3,
characterized in that,
in step (b), a data record for the resource (130) which a supply element (20) supplies to the service provider (30) is also created in a third data memory, and a cross-reference is produced from the data record in the first data memory (150) for the supply element (20) to the data record in the third data memory (170) for the resource (130),
in step (d), a determination is also made as to which resource (130.c) the chosen supply element (20.c) supplies,
the information which is obtained about the chosen supply element (20.c) in step f) includes the information about which other supply elements supply the chosen supply element (20.c), in order that the chosen supply element (20.c) can supply the resource (130.c) to subsequent supply elements or to the system provider (30),
and, in step g), a data record for the resource (130.b) which the supplying supply element (20.b) supplies to the supply element (20.c) chosen in step (d) is created in the third data memory (170) for each supply element (20.b) which supplies the chosen supply element (20.c) directly, and a cross-reference is produced from the data record in the first data memory (150) for the supplying supply element (20.b) to the data record in the third data memory (170) for the resource (130).

15. The method as claimed in claim 14,
characterized in that
a third method step is carried out, after which the second data memory (160) no longer contains any entry for a supply element (20),
with the third method step comprising:
for at least one resource (130), at least two data records for this resource (130) being replaced by a new data record for this resource (130) in the third data memory (170),
all the data records for a supply element (20) which supplies this resource (130) to subsequent supply elements and/or to the system provider being replaced by a new data record for this supply element (20) in the first data memory,
and a cross-reference being produced from the new data record for the resource (130) to the new data record for the supply element (20).

16. The method as claimed in claim 14,
characterized in that
the following information is stored for at least one resource (130) in the third data memory (170),
what designations the supply elements which supply this resource (130) use for this resource (130), and
what designations the supply elements to which this resource (130) is supplied, and/or the system provider (30) use/uses for this resource (130).

17. The method as claimed in claim 16,
characterized in that
the designation for a resource comprises a part number and/or a name.

18. The method as claimed in claim 1,
characterized in that
the information which is determined automatically in step ii) additionally includes the information about which other supply elements in the network (10) are supplied directly by this supply element (20).

19. The method as claimed in claim 3,
characterized in that,
for at least one chosen supply element (20.c), the information which is created by the question to the chosen supply element (20.c) in step (f) additionally includes the information about which other supply elements in the network (10) are supplied by the chosen supply element (20.c).

20. The method as claimed in claim 3,
characterized in that
the entry in the second data memory (160) for at least one chosen supply element (20.c) includes the information about the time at which a question was sent to this supply element (20.c) in step (e).

21. The method as claimed in claim 20,
characterized in that
when, after a defined time interval from the time at which the question was sent to the chosen supply element (20.c), no information is available from this supply element,
a further question is sent to this supply element (20.c).

22. The method as claimed in claim 3,
characterized in that,
in contrast to step (g), a data record is created for a supply element (20.b) which supplies the chosen supply element (20.c) directly only if it is found automatically that the supplying supply element (20.b) satisfies a specific criterion, and, in contrast to step (i), an entry is created for a supply element (20.b) which supplies the chosen supply element (20.c) directly only when it is automatically found that the supplying supply element (20.b) satisfies this criterion.

23. The method as claimed in claim 22,
characterized in that
the criterion: is satisfied
when the supplying supply element (20.b) supplies a resource
which has been constructed for use in the end product which the system provider (30) manufactures.

24. The method as claimed in claim 22,
characterized in that
the criterion is not satisfied
when the supplying supply element (20.b) supplies a resource
which is a standard part or is a part available throughout the world.

25. The method as claimed in claim 3,
characterized in that
the information which is created in step (f) for at least one chosen supply element (20.c)
comprises a map of that network element of previous supply elements in the production process at whose end the chosen supply element (20.c) is located,
in that this map of the network element is stored in the first data memory (150),
and in that no entries are produced in the second data memory (160) for those supply elements which supply the chosen supply element (20.c) directly.

26. The method as claimed in claim 1,
characterized in that
at least one supply element (20) in the network (10)
uses a process stage (60) to produce a resource for subsequent supply elements or for the system provider (30) in the network (10),
and the map that is produced of the network (10) includes the information
about the processing time for this process stage (60).

27. The method as claimed in claim 1,
characterized in that
the map that is produced of the network (10) includes the information, for at least one supply element (20),
about the percentage utilization of the capacities of that supply element (20) by supplying resources to subsequent supply elements or to the system provider (30).

28. The method as claimed in claim 1,
characterized in that
at least one supply element (20) in the network (10)
temporarily stores a resource, which is produced for subsequent supply elements or for the system provider (30), in an output buffer (70),
and the map that is produced of the network (10) includes the information
about the size of this output buffer (70).

29. The method as claimed in claim 1,
characterized in that
at least one supply element (20) in the network (10) is supplied from preceding supply elements with resources,
these resources are temporarily stored in an input buffer (50),
and the map that is produced of the network (10) includes the information
about the size of this input buffer (50).

30. The method as claimed in claim 1,
characterized in that
the lead time for at least one supply element (20) in the network (10) is determined,
with the lead time describing the time interval between that time
at which the supply element (20) supplies a resource to subsequent supply elements or to the system provider (30) in the network (10),
and that time
at which the system provider (30) completes the end product using this resource or using some other resource which is produced with the aid of this resource.

31. The method as claimed in claim 30,
characterized in that
the lead time for the supply element (20) is determined from the processing times of the subsequent supply elements.

32. The method as claimed in claim 1,
characterized in that
an overall parts list is produced
which links at least one first resource (130.1) which a first supply element (20.1) supplies to the system provider (30)
to at least one second resource (130.2) which a second supply element (20.2) in the network (10) supplies to the first supply element (20.1) directly or via a supply chain (40), in order that this first supply element (20.1) can complete the first resource (130.1).

33. The method as claimed in claim 14 and claim 32,
characterized in that
the overall parts list is produced using information which is stored in the third data memory (170) and from cross-references from data records in the first data memory (150) to data records in the third data memory (170).

34. The method as claimed in claim 1,
characterized in that
an interpreter list is produced,
which, for at least one resource (130),
links the designations which the supply elements which supply this resource use for this resource, to the designations which the supply elements which are supplied with these resources use for this resource,
and the designation which the system provider (30) uses for this resource.

35. The method as claimed in claim 14 and claim 32,
characterized in that
the interpreter list is produced using information which is stored in the third data memory (170).

36. The method as claimed in claim 1,
characterized in that
the map that is produced of the network (10) is visualized using a directional graph.

37. The method as claimed in claim 36,
characterized in that
one of a number of possible display forms is chosen automatically for each supply element (20) in the network (10),
with the display form depending on at least one information about the supply element as determined automatically in step ii),
and each node for a supply element (20) in the network (10) being visualized in the directional graph, using the display form which is chosen for that supply element.

38. The method as claimed in claim 27 and claim 37,
characterized in that
the information about the supply element on which the display form depends
is the percentage utilization of the capacities of the supply element (20) as a result of the supply of resources to subsequent supply elements or to the system provider (30).

39. The method as claimed in claim 36,
characterized in that
one of a number of possible display forms is chosen for each edge of the directional graph,
with the display form for an edge which links a node for a first supply element (20.1) to a node for a subsequent supply element (20.2) or for the system provider (30)
depending on the resource which the first supply element (20.1) supplies to the subsequent supply element (20.2) or to the system provider (30).

40. A method for producing a map of a network element (10) of supply elements (20) in a production process
in which the supply elements (20) comprise workshops and/or service providers,
in which resources are supplied from two or more supply elements (20) to a system provider (30) who uses these resources to manufacture an end product,
in which any desired number of supply elements (20) reside relative to one another in a networked supply chain (40) so that they are in turn supplied with resources from other supply elements (20),
and in which a previously determined supply element is the source of the network element,
with the method comprising the steps which are carried out using at least one data processing system, in that
in that a first step is first of all carried out, which comprises two step elements (a) and (b), with
a) a data record for the previously determined supply element and a data record for the system provider (30) being produced in a first data memory (150),
b) an entry for the previously determined supply element being produced in a second data memory (160),
in that a second step is subsequently carried out, which comprises seven step elements (c), (d), (e), (f), (g), (h) and (i), with
c) a supply element (20.c) being chosen by automatically choosing an entry for a supply element (20.c) in the second data memory (160),
d) the chosen entry being evaluated in order to produce a question to the chosen supply element (20.c),
e) the question obtaining information about the chosen supply element (20.c), comprising the information about which other supply elements the chosen supply element (20.c) supplies directly, and whether the chosen supply element (20.c) supplies the system provider (30) directly,
f) a data record for the supplied supply element (20.b) being created in the first data memory (150) for each supply element (20.b) which is supplied directly via the chosen supply element (20.c), and the information that the supplied supply element (20.b) is supplied directly from the chosen supply element (20.c) being entered in the first data memory (150),
g) if the chosen supply element (20.c) supplies the system provider (30) directly, the information that the system provider (30) is supplied directly by the chosen supply element (20.c) being entered in the first data memory (150),
h) an entry being produced in the second data memory (160) for each supply element (20.b) which is supplied directly from the chosen supply element (20.c), and
i) the entry for the chosen supply element (20.c) being removed from the second data memory (160)
and in that the second step is repeated until the second data memory (160) no longer contains any entry for a supply element (20).

41. A device for carrying out the method as claimed in one of claims 1 to 40.
